(19) United States
(12) Patent Application Publication
(10) Pub. No.: US 2011/0008587 A1
(43) Pub. Date: Jan. 13, 2011

(54) Edge glow protection for composite component

(76) Inventor: Edward Ruskin, Bristol (GB)

Correspondence Address: NIXON & VANDERHYE, PC, 901 NORTH GLEBE ROAD, 11TH FLOOR, ARLINGTON, VA, 22203, US

(21) Appl. No.: 12/801,742

(22) Filed: Jun. 23, 2010

(30) Foreign Application Priority Data
Jul. 10, 2009 (GB) 0912016.3

(51) Int. Cl. B32B 3/04; B32B 37/00

(52) U.S. Cl. 428/192; 156/216; 156/91

(57) ABSTRACT

A composite component comprises a co-cured stack of composite laminate plies, and has a lateral edge between opposing first and second surfaces. The lateral edge is free of laterally facing cut ply edges, and at least one of the plies has a cut ply edge substantially flush with and facing outwardly from the second surface. The component may be joined to a second component such that the one or more outwardly facing cut ply edges face towards the second component. Eliminating exposed cut ply edges protects against edge glow. Also, methods of forming the composite component.

### FIELD OF THE INVENTION

The present invention relates to a composite component comprising a co-cured stack of composite laminate plies, which is less susceptible to edge glow.

### BACKGROUND OF THE INVENTION

FIG. 1 is a schematic cross-sectional view through an aircraft wing box. The wing box has a pair of C-section spars 1, 2 and upper and lower covers 3, 4 which define the walls of a fuel tank containing fuel 5. FIG. 2 shows in detail the joint between a cap 6 of the spar 1 and the upper cover 3.

The spar cap 6 is formed from a series of plies of carbon fibre-reinforced epoxy resin. Some of the layers of carbon fibre 7 are shown in FIG. 2, and these fibres terminate at a cut edge 8. If a lightning strike 9 hits the upper cover 3, then current 10 tends to run along a bronze mesh (not shown) on the external surface of the cover 3, down the metal fasteners 12 which join the spar cap to the cover, and along the carbon fibre layers in the spar cap 6 up to the cut edge 8 which is a potential source of edge glow 13. Note that the epoxy resin between the fibres is highly resistive so current tends not to flow between adjacent plies of the composite material.

Regulations require that commercial aircraft must be able to withstand two lightning strikes per year of up to 280,000 Amps.

One solution to the problem of edge glow is presented in US2008/0128430. The cut laminate edge is sealed with an edge seal produced from a prepreg form using a thermosetting resin matched to the characteristics of the resin used in the laminate. The prepreg form can be applied to the cut laminate edge either before or after the laminate is cured, optionally with an epoxy film adhesive. The edge seal acts as a dielectric layer that both electrically insulates the cut laminate edge from the fuel and mechanically contains energetic particles produced at the edge due to lightning strikes or other sources of electrical charges.

US2008/0128430 suffers a number of problems. Firstly the prepreg material which forms the edge seal is brittle and likely to shatter in the event of a lightning strike. Specifically, a lightning strike can result in the generation of high pressure gasses and/or plasma at the cut edge which may shatter the edge seal. Secondly the bond between the prepreg material and the cut edge is relatively brittle, so the gasses and/or plasma may cause the bond to shatter. Finally the U-shaped cross-sectional profile of the edge seal means that it is difficult to join the laminate to another component. Specifically: a) a joggle or cut-out must be formed in the laminate or the other component in order to accommodate one flange of the edge seal which is sandwiched between them; and b) the edge seal cannot be fitted after the laminate has been joined to the other component. Also, it is difficult to remove and replace the edge seal for inspection or repair purposes. This is because it is necessary to dismantle the joint in order to remove the seal, and because the nature of the adhesive bond between the cut edge and the prepreg makes it physically difficult to break.

### SUMMARY OF THE INVENTION

A first aspect of the invention provides a composite component comprising a co-cured stack of composite laminate plies, and having a lateral edge between opposing first and second surfaces, wherein the lateral edge is free of laterally facing cut ply edges, and wherein at least one of the plies has a cut ply edge substantially flush with and facing outwardly from the second surface.

A second aspect of the invention provides an assembly comprising a first component, which is a component according to the first aspect, joined to a second component; wherein the second component has a mating surface, and the second surface of the first component is disposed against the mating surface of the second component, such that the one or more outwardly facing cut ply edges of the first component face towards the mating surface of the second component.

A third aspect of the invention provides a method of forming a composite component comprising: laying a stack of composite laminate plies on a tool, a cut ply edge of at least the uppermost one of the plies in the stack overhanging the plies beneath it; and co-curing the stack of plies, whereby the overhanging portion of at least the uppermost one of the plies in the stack is turned downwardly to cover the plies beneath it, such that the composite component formed has a lateral edge free of laterally facing cut ply edges and the cut ply edge of at least the uppermost ply is substantially flush with and faces towards the tool.

A fourth aspect of the invention provides a method of forming a composite component comprising: laying a stack of composite laminate plies in a recess of a tool; and co-curing the stack of plies, whereby a cut ply edge of at least the first ply laid is turned so as to lie substantially flush with the outer surface of the last ply laid and faces outwardly from the tool recess, such that the composite component formed has a lateral edge free of laterally facing cut ply edges.

A fifth aspect of the invention provides a method of joining a first component, which is a component formed by the method of the third or fourth aspects, to a second component having a mating surface, the method comprising bringing the second surface of the first component together with the mating surface of the second component such that the one or more outwardly facing cut ply edges of the first component face towards the mating surface of the second component, and co-curing the first and second components.

The invention is advantageous in that the exposed lateral edge of the composite component is free of cut ply edges, which significantly reduces or eliminates the possibility of edge glow at the lateral edge. This is achieved without the need for capping of the lateral edge. This reduces part count, manufacturing time, ease of assembly to other components, and serviceability. By turning one or more of the plies at the lateral edge, the component may also exhibit improved strength. The turned plies can transfer load more efficiently into the second component of the assembly and reduce stress concentrations, and the lateral edge is less susceptible to delamination due to the elimination of exposed cut ply edges.

Preferably, at least 50% of the plies have a cut ply edge substantially flush with and facing outwardly from the second surface. Most preferably, all but one of the plies have a cut ply edge substantially flush with and facing outwardly from the second surface. One of the plies in the stack will form the second surface and so cannot be turned to face outwardly from that surface.

In a preferred embodiment, the lateral edge has a concave profile. This may be achieved by turning all but one of the plies, which reduces voids in the laminate structure so giving a high structural integrity and low possibility of edge glow.

The component may have a plurality of lateral edges free of laterally facing cut ply edges, and preferably has no exposed cut ply edges when assembled with other components. This may not be possible in all circumstances, and so some capping of exposed cut ply edges may still be required. For example, some components, such as reinforcing stringers, have an upstanding web that is typically not joined to other components and so the exposed edge of the web may need to be capped.

The laminate plies may include unidirectional or woven fibres of conductive material, such as carbon fibres. These may be embedded in a polymer matrix, such as epoxy.

In the assembly, a resin based sealant may be disposed between the second surface of the first component and the mating surface of the second component. The sealant may be applied prior to co-curing the components. This acts to seal around the edge of the outermost ply in the stack.

The first and second components may be fastened together by one or more fasteners.

The first component may be any component that is to be joined by its second surface to a second component so as to cover the exposed cut ply edges. In an aerospace application, the first component may be a stringer, rib or spar and the second component may be an aircraft wing cover. However, this invention is applicable to virtually any aerospace or non-aerospace application where edge glow is an issue, as will be appreciated by those skilled in the art.

The method of forming the composite component may further comprise vacuum bagging or autoclaving the stack of plies on the tool.

### BRIEF DESCRIPTION OF THE DRAWINGS

Embodiments of the invention will now be described with reference to the accompanying drawings, in which:

FIG. 1 is a sectional view of a fuel tank in an aircraft wing;

FIG. 2 is a sectional view of a prior art joint between a spar cap and an upper cover;

FIG. 3 is a sectional view of a joint between a spar cap and an upper cover according to this invention;

FIG. 4 is a sectional view of a stack of laminate plies on a mould tool for forming an edge of the spar cap;

FIG. 5 is a sectional view of the stack of FIG. 4 after consolidation;

FIG. 6 is a sectional view of a stack of laminate plies on an alternative mould tool for forming the edge of the spar cap;

FIG. 7 is a sectional view of the edge of the spar cap after removal from the tool and cutting;

FIGS. 8 to 11 show sectional views of first to fourth alternative stack formations at the edge of the spar cap; and

FIGS. 12a to 12f show various joints between composite components with modified edges to reduce edge glow circled.

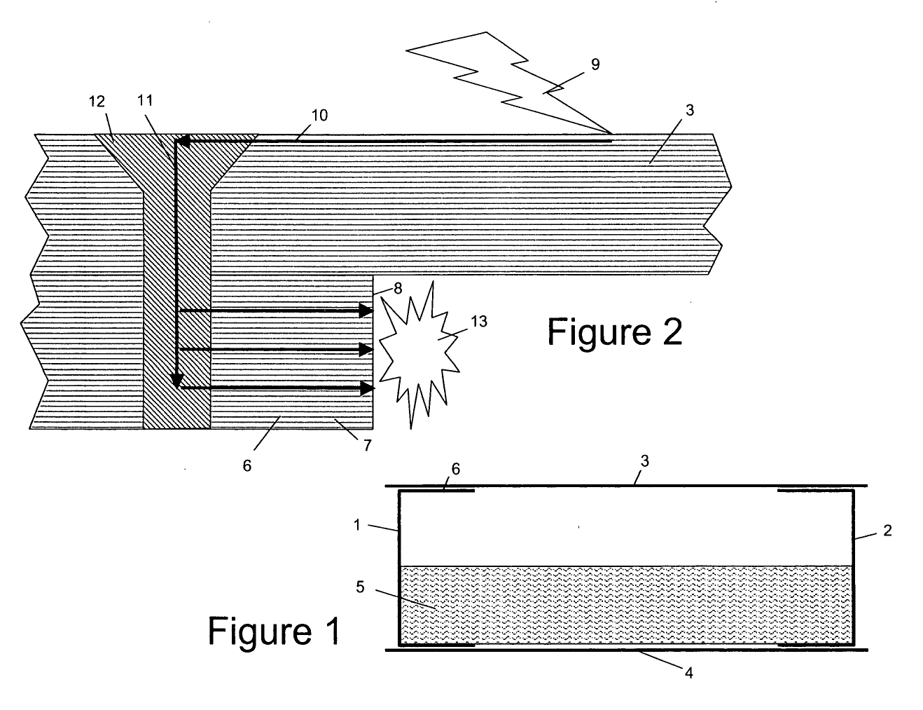

### DETAILED DESCRIPTION OF EMBODIMENT(S)

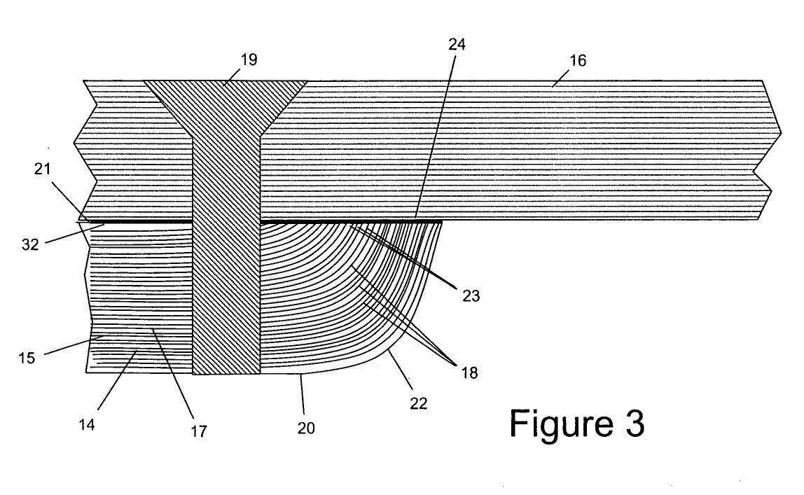

FIG. 3 shows in detail a joint between a cap 14 of a C-section spar 15 and an upper wing cover 16, which define, in part, walls of a fuel tank of an aircraft wing box.

The spar cap 14 is formed from a stack of plies 17 of carbon fibre-reinforced epoxy resin. The upper wing cover 16 is also formed from a stack of plies of carbon fibre-reinforced epoxy resin. Metal fasteners 19 are used to join the spar cap 14 to the upper cover 16.

The spar cap 14 has opposing first and second surfaces 20, 21 substantially parallel with the plane of the stack of plies 17 of the spar cap 14. A lateral edge 22 extends between the first and second surfaces 20, 21. The plies 17 each terminate at a cut ply edge 23. Unlike the joint shown in FIG. 2, the cut ply edges 23 of the plies 17 are not exposed at the lateral edge 22. Instead, the cut ply edges 23 are substantially flush with the second surface 21 and face outwardly therefrom.

This is achieved through turning the plies in the region of the lateral edge 22 upwardly out of the plane of the stack of plies 17. The amount by which the plies 17 are turned is dependant upon their position in the stack. The uppermost one of the plies 17 is disposed at the second surface 21 and so is not turned at the lateral edge 22. The lowermost one of the plies 17 in the stack is tuned through nearly 90 degrees so as to extend from the first surface 20 to the second surface 21 and faces upwardly from the second surface. The intermediate ones of the plies 17 are each turned upwardly such that their cut ply edges 23 are substantially flush with the second surface 21 and face upwardly therefrom.

Since all but one of the plies in the stack are turned upwardly so that their cut ply edges 23 are flush with the second surface 21, the lateral edge 22 has a concave profile. This beneficially also reduces stress concentrations at the lateral edge 22 and load in the spar cap 14 is progressively transferred into the upper cover 16.

The second surface 21 of the spar cap faces a mating surface 24 of the upper cover 16. A resin based sealant 32, such as epoxy, is disposed between the mating surface 24 and the second surface 21 to seal the cut ply edges 23 of the plies 17.

If a lightning strike hits the upper cover 16, and current runs down the metal fasteners 19 there are no exposed cut fibre edges in the joint shown in FIG. 3 which could be a potential source of edge glow, unlike the joint shown in FIG. 2. This reduces or eliminates edge glow, which is crucial particularly in aircraft fuel tanks.

The edge of the spar cap 14 may be formed in various ways. FIG. 4 shows the stack of plies 17 shown inverted on a mould tool 25. Each ply in the stack has a cut ply edge which overlaps the ply beneath it. The plies 17 are unidirectional carbon fibre pre-impregnated with epoxy resin, so called “prepreg”. Only part of the mould tool 25 is shown in FIG. 4, the remainder of the tool being appropriately shaped to form the C-section spar 15. The prepreg layers on the tool are consolidated by covering with a vacuum bag 26. A seal 27 may be required to adequately seal the vacuum bag 26 to the mould table 28 which supports the tool 25. Air is removed via port 29 using a vacuum pump (not shown) from within the vacuum bag 26 to apply pressure to the stack of “wet” prepreg layers.

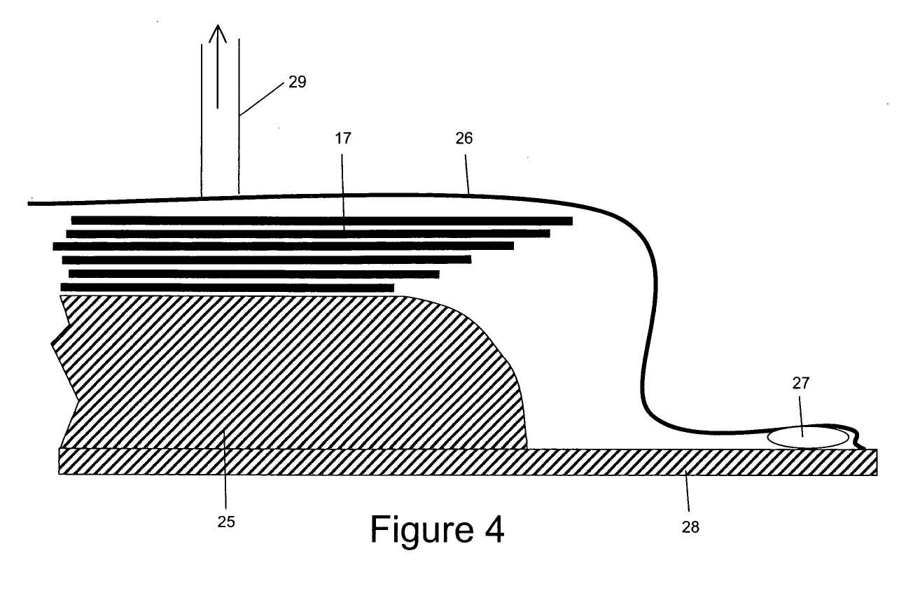

The consolidated stack is shown in FIG. 5. The plies 17 deform over each other during the consolidation process so that their cut edges are turned downwardly to cover the plies beneath them. The tool 25 has a curved edge profile to encourage the plies to turn downwardly during the consolidation process. The consolidated stack of plies is left to cure at room temperature, or heat may be applied using an autoclave, for example, depending on the type of resin used.

An alternative method of forming the spar component 15 uses a recessed mould tool 30. The plies 17 are laid-up in the mould tool. The curvature at the edge of the recess in the mould tool 30 turns the plies upwardly, except for the last ply laid which will form the second surface of the component. The first ply laid is the longest and the last ply laid is the shortest. A second mould tool may be brought down to consolidate the stack, or a vacuum bagging operation may be used similar to that described previously. The stack of “wet” prepreg plies is then left to cure at room temperature, or heat may be applied using an autoclave, for example, depending on the type of resin used.

Once the resin has cured the spar component 15 is removed from the mould tool 25 or 30. Ideally, the wet prepreg layers would be cut such that once the spar component has been consolidated and cured, the cut ply edges 23 would lie exactly flush with the second surface 21. However, manufacturing tolerances will normally require that the wet prepreg layers are cut oversize (as shown in FIGS. 5 and 6) such that these edges have to be trimmed after cure so as to avoid air pockets or resin voids in the completed spar component 15.

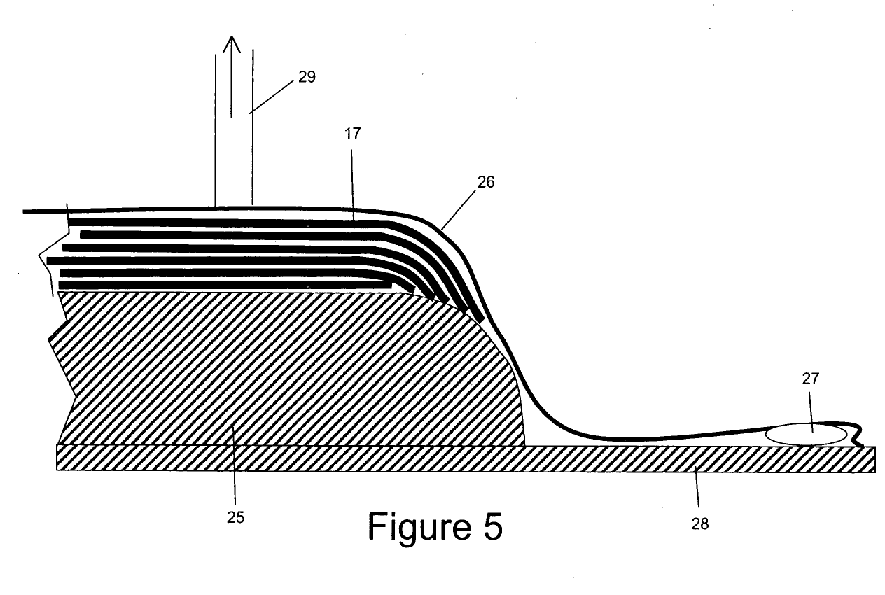

FIG. 7 shows the edge of the spar cap 14 of the completed spar component 15 with the arrow 31 indicating the cut line to trim the cut ply edges 23 flush with the second surface 21.

The spar 15 is then married up to the upper cover 16, which has been separately formed. The sealant 32 is applied between the second surface 21 of the spar cap 14 and the mating surface 24 of the upper cover 16. The spar 15 and the upper cover 16 and then co-cured to cure the sealant 32. Note that the spar 15 and the upper cover 16 must have each been previously cured prior to joining together. The sealant 32 ensures there are no exposed cut ply edges in the joint. Finally, fastener holes are drilled and the fasteners 19 installed to secure the joint.

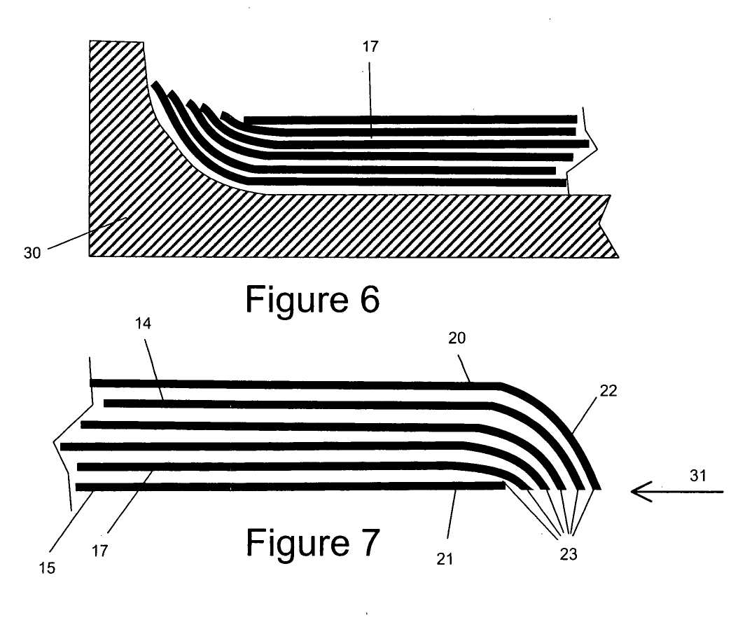

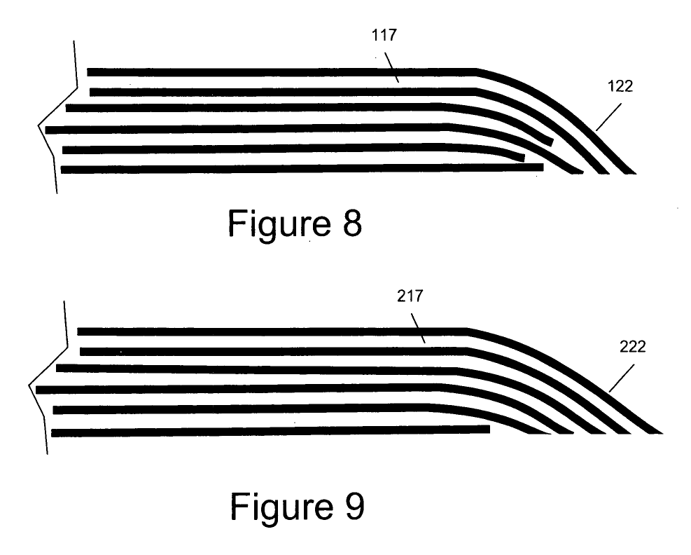

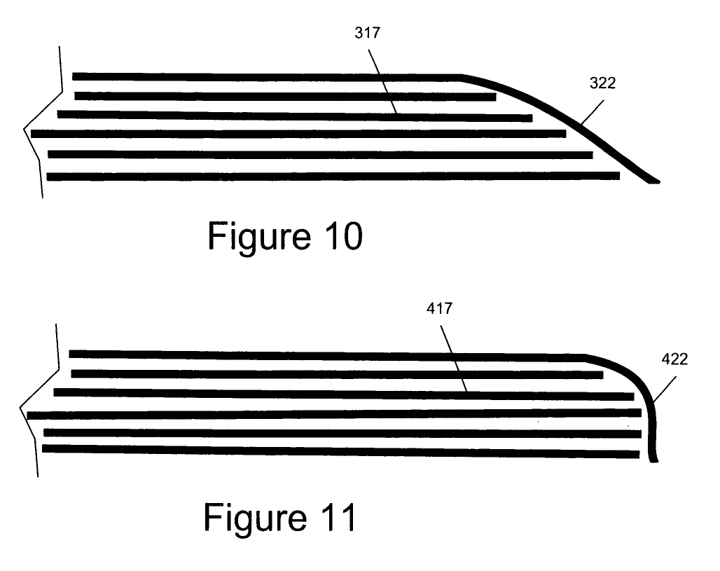

FIGS. 8 to 11 show first to fourth alternative stack formations at the edge of the spar cap. In FIG. 8, some of the plies 117 are terminated inboard of the lateral edge 122 to reduce the thickness of the ply stack at the lateral edge. In FIG. 9, the plies 217 are turned through a lesser angle to create a ramp at the lateral edge 222. In FIG. 10, a ramped lateral edge 322 is formed by turning down only the uppermost one of the plies 317 to form a cover ply over the remaining ones of the plies 317, which are terminated successively through the stack thickness direction. In FIG. 11, the lateral edge 422 is blunt and only the uppermost one of the plies 417 is turned down to form a cover ply over the remaining ones of the plies 417. These are just some examples of variants envisaged within the scope of this invention.

It is to be noted that there is generally a trade off between ease of manufacture and the amount of edge glow protection and structural integrity afforded by the edge profiles described above. For example, edge glow protection and structural integrity are generally improved by turning as many plies as possible in the stack such that their cut ply edges face outwardly at as close to 90 degrees as possible from the second surface of the component.

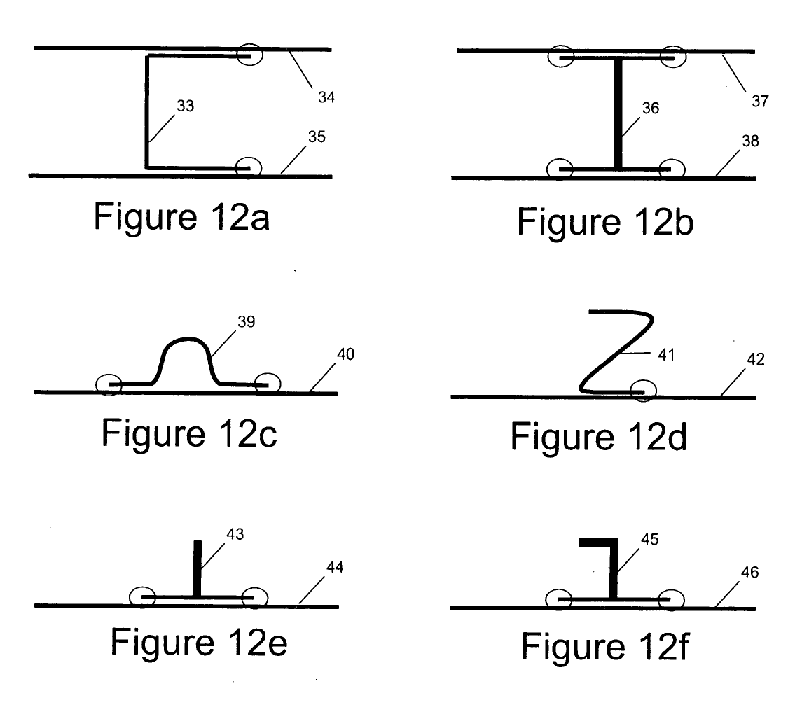

FIGS. 12a to 12f show various joints between composite components with modified edges according to this invention to reduce edge glow circled. FIG. 12a shows a C-section spar 33 joined between two panels 34, 35. FIG. 12b shows an I-beam 36 (formed of two back-to-back C-section beams) joined between two panels 37, 38.

FIG. 12c shows a “top-hat” stringer 39 joined to a panel 40. FIG. 12d shows a Z-section stringer 41 joined to a panel 42. FIG. 12e shows a T-section stringer 43 (formed of two back-to-back L-section beams) joined to a panel 44. FIG. 12f shows a J-section stringer 45 joined to a panel 46.

The components 33, 36, 39, 43 and 45 each have at least two edges (circled), which are free of exposed cut ply edges. The plies in these components are turned at these edges such that their cut ply edges face towards the other components involved in the respective joints. The assemblies shown in FIGS. 12a, 12b, and 12c have no exposed cut ply edges. This provides the best protection against edge glow. This may not be possible in all circumstances, and so some capping of exposed cut ply edges may still be required. For example, the components 41, 43 and 45 have an upstanding portion that is typically not joined to other components and so may need to be capped to protect against edge glow. However, it is relatively easy to cap edges of components that are not joined to other components.

Although the invention has been described above with reference to one or more preferred embodiments, it will be appreciated that various changes or modifications may be made without departing from the scope of the invention as defined in the appended claims.

1. A composite component comprising a co-cured stack of composite laminate plies, and having a lateral edge between opposing first and second surfaces, wherein the lateral edge is free of laterally facing cut ply edges, and wherein at least one of the plies has a cut ply edge substantially flush with and facing outwardly from the second surface.

2. A component according to claim 1, wherein at least 50% of the plies have a cut ply edge substantially flush with and facing outwardly from the second surface.

3. A component according to claim 1, wherein all but one of the plies have a cut ply edge substantially flush with and facing outwardly from the second surface.

4. A component according to claim 1, wherein a profile of the lateral edge is concave.

5. A component according to claim 1, having a plurality of lateral edges free of laterally facing cut ply edges.

6. A component according to claim 1, wherein the laminate plies include conductive fibres.

7. An assembly comprising a first component, which is a component according to claim 1, joined to a second component;
wherein the second component has a mating surface, and the second surface of the first component is disposed against the mating surface of the second component, such that the one or more outwardly facing cut ply edges of the first component face towards the mating surface of the second component.

8. An assembly according to claim 7, wherein a resin based sealant is disposed between the second surface of the first component and the mating surface of the second component.

9. An assembly according to claim 7, wherein the first and second components are fastened together by one or more fasteners.

10. An assembly according to claim 7, wherein the first component is a stringer, rib or spar, and the second component is an aircraft wing cover.

11. A method of forming a composite component comprising:
laying a stack of composite laminate plies on a tool, a cut ply edge of at least the uppermost one of the plies in the stack overhanging the plies beneath it; and
co-curing the stack of plies, whereby the overhanging portion of at least the uppermost one of the plies in the stack is turned downwardly to cover the plies beneath it, such that the composite component formed has a lateral edge free of laterally facing cut ply edges and the cut ply edge of at least the uppermost ply is substantially flush with and faces towards the tool.

12. A method of forming a composite component comprising:
laying a stack of composite laminate plies in a recess of a tool; and
co-curing the stack of plies, whereby a cut ply edge of at least the first ply laid is turned so as to lie substantially flush with the outer surface of the last ply laid and faces outwardly from the tool recess, such that the composite component formed has a lateral edge free of laterally facing cut ply edges.

13. A method according to claim 11 or 12, further comprising vacuum bagging or autoclaving the stack of plies on the tool.

14. A method of joining a first component, which is a component formed by the method of claim 11, to a second component having a mating surface, the method comprising bringing the second surface of the first component together with the mating surface of the second component such that the one or more outwardly facing cut ply edges of the first component face towards the mating surface of the second component, and co-curing the first and second components.

15. A method according to claim 14, further comprising applying a resin based sealant between the second surface of the first component and the mating surface of the second component, prior to co-curing the components.

16. A method according to claim 14, further comprising fastening the first and second components together.
